(19) United States
(12) Patent Application Publication
(10) Pub. No.: US 2025/0392163 A1
(43) Pub. Date: Dec. 25, 2025

(54) RECTIFIER CABLE AND RECTIFIER CONNECTOR

(71) Applicant: TOYODA GOSEI CO., LTD., Kiyosu-shi (JP)

(72) Inventors: Atsushi SUGIHARA, Kiyosu-shi (JP); Yuki TOKUYAMA, Kiyosu-shi (JP); Kengo SUMIYA, Kiyosu-shi (JP); Hiroyuki ASANO, Kiyosu-shi (JP); Tsubasa SUZUKI, Kiyosu-shi (JP); Teppei YAMAKOSHI, Kiyosu-shi (JP)

(21) Appl. No.: 19/228,169

(22) Filed: Jun. 4, 2025

(30) Foreign Application Priority Data
Jun. 25, 2024 (JP) 2024-102019

(51) Int. Cl. H02J 50/00; H02J 50/20

(52) U.S. Cl. CPC H02J 50/005; H02J 50/20

(57) ABSTRACT

A rectifier cable includes a cable main body electrically connected to a control board, and a rectifier unit that is electrically connected to the cable main body and electrically connected to an antenna capable of transmitting and receiving a power transmission signal so as to rectify an AC signal input from the antenna to a DC signal and output the DC signal to the cable main body.

### CROSS-REFERENCE TO RELATED APPLICATIONS

The present patent application claims the priority of Japanese patent application No. 2024/102019 filed on Jun. 25, 2024, and the entire contents of Japanese patent application No. 2024/102019 are hereby incorporated by reference.

### TECHNICAL FIELD

The present invention relates to a rectifier cable and a rectifier connector.

### BACKGROUND ART

A contactless power supply device is known which supplies power to a contactless power receiving device in a contactless manner (see, e.g., Patent Literature 1).

The contactless power supply device is configured to estimate the length of a cable from frequency characteristics at the time that a high-frequency oscillator oscillates the cable, and based on the estimated cable length, compensate for the effect of the cable length when transmitting power to a transmission antenna from a tuning and matching unit for power transmission.

### CITATION LIST

### Patent Literatures

Patent Literature 1: JP 2015/204739 A

### Summary of Invention

The problem of the known contactless power supply devices is that power transmission loss occurs on the contactless power receiving device side due to the length of the cable and connector portions, resulting in a decrease in power reception efficiency.

It is an object of the invention to provide a rectifier cable and a rectifier connector that are capable of improving the power reception efficiency.

One aspect of the invention provides a rectifier cable, comprising:
a cable main body electrically connected to a control board; and
a rectifier unit that is electrically connected to the cable main body and also electrically connected to an antenna capable of transmitting and receiving a power transmission signal, and rectifies an AC signal input from the antenna to a DC signal and outputs the DC signal to the cable main body.

Another aspect of the invention provides a rectifier connector, comprising:
a board-side connector electrically connected to a control board;
an antenna-side connector electrically connected to an antenna capable of transmitting and receiving a power transmission signal; and
a rectifier unit that is electrically connected to the board-side connector at one end and also electrically connected to the antenna-side connector at another end, rectifies an AC signal input from the antenna through the antenna-side connector to a DC signal and outputs the DC signal to the control board through the board-side connector.

### Advantageous Effects of Invention

According to the invention, it is possible to improve the power reception efficiency.

### BRIEF DESCRIPTION OF DRAWINGS

FIG. 1 is a diagram illustrating an example of a wireless power supply system using a rectifier cable in the first embodiment.

FIG. 2 is a diagram illustrating an example of the rectifier cable in the first embodiment.

FIG. 3 is a diagram illustrating an example of the rectifier cable in the second embodiment.

FIG. 4 is a diagram illustrating an example of a rectifier connector in the third embodiment.

### DESCRIPTION OF EMBODIMENTS

### Short Summary of the Embodiments

The rectifier cable in the embodiments generally includes a cable main body electrically connected to a control board, and a rectifier unit that is electrically connected to the cable main body and also electrically connected to an antenna capable of transmitting and receiving a power transmission signal, and rectifies an AC signal input from the antenna to a DC signal and outputs the DC signal to the cable main body.

Then, a rectifier connector in another embodiment generally includes a board-side connector electrically connected to a control board, an antenna-side connector electrically connected to an antenna capable of transmitting and receiving a power transmission signal, and a rectifier unit that is electrically connected to the board-side connector at one end and also electrically connected to the antenna-side connector at the other end, rectifies an AC signal input from the antenna through the antenna-side connector to a DC signal and outputs the DC signal to the control board through the board-side connector.

The rectifier cable and the rectifier connector rectify an AC signal output from the antenna to a DC signal and then output the DC signal to the control board. Therefore, power reception efficiency can be improved as compared to when the AC signal flows through a transmission line to the control board.

### First Embodiment

### (General Configuration of a Rectifier Cable 1)

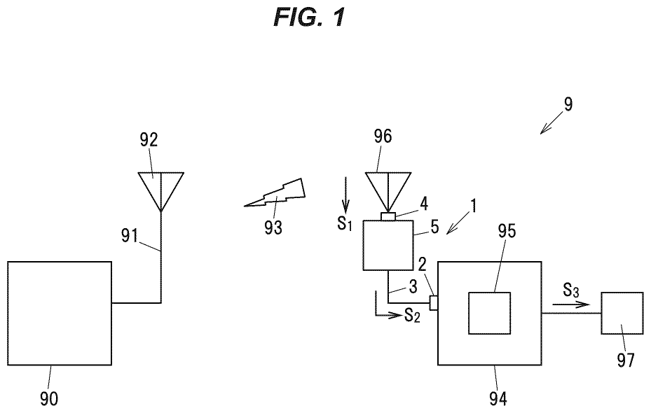

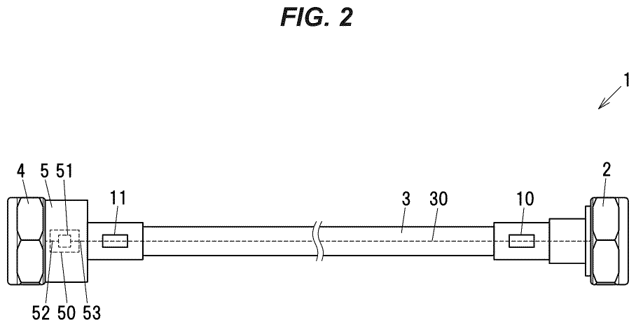

FIG. 1 is a diagram illustrating an example of a wireless power supply system using a rectifier cable in the first embodiment. FIG. 2 is a diagram illustrating an example of the rectifier cable in the first embodiment. In each drawing of the embodiments described below, a scale ratio or shape may be different between the drawings or different from an actual ratio or shape. In addition, in FIG. 1, flows of main signals, etc., are indicated by arrows. A general description of the rectifier cable 1 in the first embodiment will be provided below.

As shown in FIG. 1, the rectifier cable 1 is used as a cable that electrically connects an antenna 96 to a control board 95 in a wireless power supply system 9. This electrical connection may be made with plural conductors, such as electronic components, interposed therebetween as long as the rectifier cable 1 and the control board 95 are not insulated from each other. In addition, electrical connection between the antenna 96 and the rectifier cable 1 may be made with plural conductors, such as other cables, interposed therebetween as long as the distance over which an AC signal S₁ (described below) flows is within an allowable range of power transmission loss.

The wireless power supply system 9 generally mainly includes a power transmitting device 90, and a power receiving device 94 having the control board 95. The wireless power supply system 9, e.g., converts a power transmission signal, which is output as high-frequency (RF: Radio Frequency, AC: Alternating Current) power from the power transmitting device 90, into power S₃ at the control board 95 and charges the charging device 97. The control board 95 is configured to perform control related to charging of the charging device 97.

In the first embodiment, the power transmitting device 90 outputs microwave 93 as the power transmission signal through a cable 91 and an antenna 92. In the power receiving device 94, the control board 95 converts the microwave 93 into the power S3 and charges the connected charging device 97. The power receiving device 94 may supply the power S₃ to a device other than the charging device 97.

As shown in FIGS. 1 and 2, the rectifier cable 1 in the first embodiment generally includes a cable main body 3 electrically connected to the control board 95, and a rectifier unit 5 that is electrically connected to the cable main body 3 and also electrically connected to the antenna 96 capable of transmitting and receiving the microwave 93, and rectifies the AC signal S₁ input from the antenna 96 to a DC signal S₂ and outputs the DC signal S₂ to the cable main body 3.

The rectifier cable 1 in the first embodiment also includes a board-side connector 2 electrically connected to the control board 95, and an antenna-side connector 4 electrically connected to the antenna 96 that is capable of transmitting and receiving the microwave 93. The rectifier cable 1 may be configured such that at least the board-side connector 2 is attached to the cable main body 3 which has been cut to a desired length.

As shown in FIG. 2, the rectifier unit 5 in the first embodiment is arranged between the board-side connector 2 and the antenna-side connector 4 so as to be located on the antenna-side connector 4 side.

The rectifier cable 1 is not limited to being connected to the control board 95 of the power receiving device 94, and may be connected to a control board of the power transmitting device 90 or a control board of a power transmitting and receiving device, as a modification. The rectifier cable 1, when connected to the power transmitting device 90 or the power transmitting and receiving device, has a switching unit to bypass the rectifier unit 5 at the timing to transmit power.

### (Configuration of the Rectifier Cable 1)

As described above, the rectifier cable 1 generally includes the board-side connector 2, the cable main body 3, the antenna-side connector 4, and the rectifier unit 5.

The board-side connector 2 and the antenna-side connector 4 are connectors such as SMA (Sub Miniature Type A), SMP (Sub Miniature Push-on) and U.FL (manufactured by Hirose Electric) as an example, but are not limited thereto. In addition, the board-side connector 2 and the antenna-side connector 4 may be the same or different. The cable main body 3 is a coaxial cable as an example, but may be a conductor such as an IV cable.

As shown in FIG. 1, the antenna-side connector 4 is connected to the antenna 96. The antenna 96 may be any antenna which is capable of receiving the microwave 93.

As an example, the rectifier unit 5 has a substrate 50 on which transmission lines and a rectifier circuit 51 having an impedance matching constant, a rectifying element and a smoothing capacitor, etc. are mounted, and it is configured to rectify AC to DC. As an example, these transmission lines are a transmission line 52 on the antenna 96 side and a transmission line 53 on the cable main body 3 side, as shown in FIG. 2. The transmission line 52, the transmission line 53, and a transmission line 30 (described later) have an impedance of, e.g., 50Ω.

The transmission line 52 is a transmission line through which the AC signal S₁ output from the antenna 96 flows. The transmission line 53 is a transmission line through which the rectified DC signal S₂ flows. This transmission line 53 is electrically connected to the transmission line 30 of the cable main body 3. Therefore, the DC signal S₂ mainly flows through the transmission line 53 and the transmission line 30.

When the rectifier unit 5 acquires the AC signal S₁ output from the antenna 96 through the antenna-side connector 4, the rectifier unit 5 rectifies the acquired AC signal S₁ to convert into the DC signal S₂, and outputs the converted DC signal S₂ to the cable main body 3. The rectifier unit 5 may be configured to perform half-wave rectification or may be configured to perform full-wave rectification.

Here, the rectifier circuit 51 is not limited to being implemented as an electronic component such as a capacitor, but may be formed as an IC (Integrated Circuit) chip and arranged on the substrate 50.

The rectifier cable 1, as an example, may include an identification mark 10 on the cable main body 3 near the board-side connector 2 and an identification mark 11 on the cable main body 3 near the antenna-side connector 4 as shown in FIG. 2, or may include an identification mark on either side, to distinguish between the antenna 96 side and the power receiving device 94 side. Furthermore, the rectifier cable 1 may be partially colored to allow for identification. However, it is not limited thereto as long as it is identifiable.

### Effects of the First Embodiment

The rectifier cable 1 in the first embodiment can improve power reception efficiency. In the rectifier cable 1, the DC signal S₂, not the AC signal S₁, flows through the cable main body 3, hence, it is possible to reduce the power transmission line loss in the connector portion or the cable main body 3 and improve the power receiving efficiency, as compared to the case where an AC signal flows through the cable main body.

Since the rectifier cable 1 can output the DC signal S₂ to the power receiving device 94 without using a specially designed rectenna, it is possible to reduce high-frequency power transmission line loss and suppress the cost while allowing the antenna 96 to be freely replaced within the range where the connector shape is compatible. In addition, since the antenna 96 can be freely replaced within the range where the connector shape is compatible, the rectifier cable 1 is more versatile than when a rectenna is used.

In the rectifier cable 1, the AC signal S₁ is rectified to a DC signal S₂ by the rectifier unit 5 located close to the antenna 96, and the transmission line 52 through which the AC signal S₁ flows is shortened. Therefore, it is possible to reduce the power transmission line loss as compared to the case where this configuration is not adopted.

### Second Embodiment

The second embodiment differs from the first embodiment in that the rectifier unit is arranged between the antenna and the antenna-side connector.

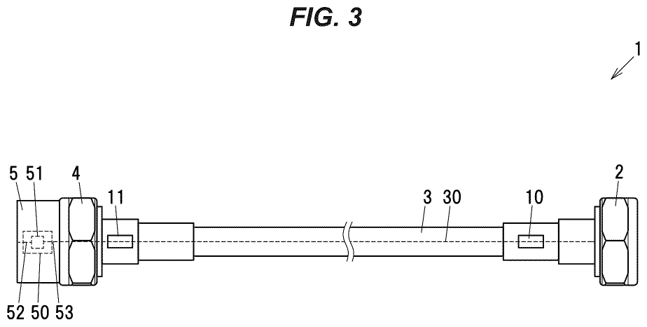

FIG. 3 is a diagram illustrating an example of the rectifier cable in the second embodiment. In the embodiments described below, portions having the same functions and structures as those in the first embodiment are denoted by the same reference signs as those in the first embodiment and the explanation thereof will be omitted.

As shown in FIG. 3, the rectifier unit 5 in the second embodiment is arranged on the antenna 96 side of the antenna-side connector 4. In other words, the rectifier unit 5 is arranged between the antenna 96 and the antenna-side connector 4.

The rectifier unit 5 is configured to allow the antenna 96 to be connected to the antenna-side connector 4. As an example, the rectifier unit 5 is configured so that the antenna 96 is directly connected to the rectifier circuit 51. Therefore, the rectifier cable 1 can minimize the length of the transmission line 52 through which the AC signal S₁ flows.

### Effects of the Second Embodiment

In the rectifier cable 1 in the second embodiment, the length of the transmission line 52 through which the AC signal S₁ flows can be minimized. Therefore, it is possible to further reduce the power transmission line loss as compared to when the length is long.

### Third Embodiment

The third embodiment differs from the other embodiments in that the rectifier unit is directly connected to the antenna-side connector and the board-side connector.

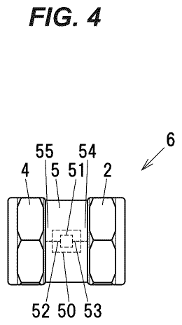

FIG. 4 is a diagram illustrating an example of a rectifier connector in the third embodiment.

As shown in FIG. 4, a rectifier connector 6 in the third embodiment generally includes the board-side connector 2 electrically connected the control board 95, the antenna-side connector 4 electrically connected to the antenna 96 capable of transmitting and receiving the microwave 93, and the rectifier unit 5 that is electrically connected to the board-side connector 2 at one end 54 and also electrically connected to the antenna-side connector 4 at the other end 55, rectifies the AC signal S₁ input from the antenna through the antenna-side connector 4 to the DC signal S₂ and outputs the DC signal S₂ to the control board 95 through the board-side connector 2.

As long as the board-side connector 2 is not insulated from the control board 95, plural conductors such as electronic components may be interposed therebetween. In addition, plural conductors such as other cables may be interposed between the antenna-side connector 4 and the antenna 96 as long as the distance over which the AC signal S₁ flows is within an allowable range of power transmission loss.

The board-side connector 2 and the antenna-side connector 4 may have the same connector shape or may have different connector shapes.

As a modification, the rectifier connector 6 may be provided with the above-mentioned identification marks 10 and 11 or may be colored to allow for identification so that the board-side connector 2 and the antenna-side connector 4 can be distinguished.

### Effects of the Third Embodiment

In the rectifier connector 6 of the third embodiment, the transmission line 52 through which the AC signal S₁ flows has the minimum length. Therefore, it is possible to reduce the power transmission line loss and improve the power receiving efficiency, as compared to when the length is long.

Since the rectifier connector 6 does not have the cable main body 3, the distance from the antenna 96 to the power receiving device 94 can be shortened and the power reception efficiency can be further improved, as compared to when having the cable main body 3.

In the rectifier connector 6, the length of the transmission line 52 through which the AC signal S₁ flow does not change even when a cable is connected to the board-side connector 2. Therefore, it is possible to suppress an increase in the power transmission line loss as compared to when the length becomes longer.

According to the rectifier cable 1 and the rectifier connector 6 in at least one of the embodiments described above, it is possible to improve the power reception efficiency.

Although some embodiments and modifications of the invention have been described, these embodiments and modifications are merely examples and the invention according to claims is not to be limited thereto. These new embodiments and modifications may be implemented in various other forms, and various omissions, substitutions and changes, etc., can be made without departing from the gist of the invention. In addition, not all combinations of the features described in the embodiments and modifications are necessary to solve the problem of the invention. Further, these embodiments and modifications are included within the scope and gist of the invention and also within the invention described in the claims and the range of equivalency.

### REFERENCE SIGNS LIST

1 RECTIFIER CABLE
2 BOARD-SIDE CONNECTOR
3 CABLE MAIN BODY
4 ANTENNA-SIDE CONNECTOR
5 RECTIFIER UNIT
6 RECTIFIER CONNECTOR
9 WIRELESS POWER SUPPLY SYSTEM
10, 11 IDENTIFICATION MARK
50 SUBSTRATE
30, 52, 53 TRANSMISSION LINE
54 ONE END
55 OTHER END
90 POWER TRANSMITTING DEVICE
91 CABLE
92 ANTENNA
93 MICROWAVE
94 POWER RECEIVING DEVICE
95 CONTROL BOARD
96 ANTENNA
97 CHARGING DEVICE

1. A rectifier cable, comprising:
a cable main body electrically connected to a control board; and
a rectifier unit that is electrically connected to the cable main body and electrically connected to an antenna capable of transmitting and receiving a power transmission signal so as to rectify an AC signal input from the antenna to a DC signal and output the DC signal to the cable main body.

2. The rectifier cable according to claim 1, further comprising:
a board-side connector electrically connected to the control board; and
an antenna-side connector electrically connected to the antenna.

3. The rectifier cable according to claim 2, wherein the rectifier unit is arranged between the antenna-side connector and the board-side connector.

4. The rectifier cable according to claim 2, wherein the rectifier unit is arranged between the antenna-side connector and the cable main body.

5. The rectifier cable according to claim 2, wherein the rectifier unit is arranged between the antenna and the antenna-side connector.

6. A rectifier connector, comprising:
a board-side connector electrically connected to a control board;
an antenna-side connector electrically connected to an antenna capable of transmitting and receiving a power transmission signal; and
a rectifier unit that is electrically connected to the board-side connector at one end and also electrically connected to the antenna-side connector at another end, rectifies an AC signal input from the antenna through the antenna-side connector to a DC signal and outputs the DC signal to the control board through the board-side connector.
